(19) United States
(12) Patent Application Publication
(10) Pub. No.: US 2019/0289225 A1
(43) Pub. Date: Sep. 19, 2019

(54) SYSTEM AND METHOD FOR GENERATING GROUP PHOTOS

(71) Applicant: Panasonic Intellectual Property Management Co., Ltd., Osaka (JP)

(72) Inventors: Vasileios VONIKAKIS, Singapore (SG); Ariel BECK, Singapore (SG); Chandra Suwandi WIJAYA, Singapore (SG)

(21) Appl. No.: 15/924,490

(22) Filed: Mar. 19, 2018

(51) Int. Cl. H04N 5/272; G06K 9/00; G06K 9/62

(52) U.S. Cl. CPC H04N 5/272; G06K 9/00302; G06F 3/04847; G06K 9/6253; G06K 9/00677

(57) ABSTRACT

A system and method for combining individual faces from a collection of group photos into a single photo based on optimal characteristics and user preferences is described. The system obtains a collection of group photos and conducts an analysis on the collection of group photos. A user may input a desired a desired facial expression and/or context. The system selects a base image and individual faces from the collection of group photos according to the desired facial expression and/or context of the user. The selected faces can be incorporated onto the base image to generate an optimal composite group photo. Multiple composite photos can be generated from the collection based on the user input.

### TECHNICAL FIELD

The embodiments described below relate to a system and method for editing digital images.

### BACKGROUND

With the advent of digital cameras and smart phones, photographs can be taken, edited and stored seamlessly. It is common to take group photos whenever people meet and get together, whether it is a casual or a professional occasion. While technology has made it cheaper and easier to take photos, it is still a difficult task to control the pose and facial expression of each person in a group photo. It can be especially challenging with young children or infants. Inevitably, someone in the group will not smile at the ideal time, will blink, or will glance away from the camera when the shutter button is pressed.

When taking group photos, people often take multiple photos and evaluate them one by one thereafter to find the best photo for that occasion. Without such an evaluation, it can be difficult to determine if any single photo is ideal or even adequate. Typically, among a collection of photos, there are flaws and drawbacks in each photo. For example, among the collection, no photo is present with all individuals having a consistent facial expression. Or there is no photo in which all individuals have their eyes open. In either case, one must choose a group photo with a flaw (often against the wishes of an individual) or resort to the use of time and resources needed for photo editing software.

U.S. Pat. No, 7,787,664B2 describes a method for recomposing photographs from multiple frames. It detects faces in a target frame and selects a target face (e.g. a face with closed eyes) for replacement. Thereafter, it detects a source face from a source frame that can be used to replace the target face in the target frame. The target face is then be replaced by the source face to generate a composite photo. In this patent, the composite photo can also be generated from a video clip. A target frame is first selected. After the target frame undergoes face detection for the target face, face tracking or face recognition is conducted among the frames in the video clip to identify a source face that is usable to replace the target face. The target face is then replaced with the source face to generate a composite photo.

This prior art compares a target face with a source face and determines which is better for a composite photo. However, optimizing a group photo should consider which face is better (e.g. a face with open eyes is better than face with closed eyes) and also the kind of expression a user desires. For example, if the user wishes to have a funny-face group photo, closed eyes may be the desired face expression. However, this prior art cannot meet such demands. Further, body pose can communicate a lot of information about context and emotion. This patent does not consider body pose in either the target frame or the source frame.

U.S. Patent Publication No. 2014/0153832A1 describes a method and system that conducts facial expression editing in images based on collections of images. It searches stored data associated with a plurality of different source images depicting a face to find one or more matching facial attributes that match desired facial attributes. The target image is edited by replacing portions in the target image with portions of the source images associated with the facial attributes. Although this prior art considers the user's desired expression, it requires the user to provide a target image. Hence, a user must review individual images and identify one as the target image which can be cumbersome and impractical.

U.S. Patent Publication No. 2011/0123118A1 describes methods, systems, and media for swapping faces in images. This prior art improves a group photo by providing portions with open eyes, smiling faces or eyes that look toward the camera. However, this simple expression recognition and replacement may not meet the demands of a modern user. For example, a user may desire a funny face for all of the group members. The system does not offer any choices or flexibility to the user. Further, it requires the user to choose a desired photo for a processing step which can be troublesome and time consuming.

### SUMMARY OF THE INVENTION

Embodiments of the invention recognize that there exists a need for a system and method to generate a user-desired group photo from a collection of group photos with minimum time and effort. The system should detect qualities such as facial expressions and body position of individuals among multiple group photos. The system should also detect and consider context in the group photos. Further, the system should analyse images of individual faces and blend the images onto a desired base image.

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, arid abstract as a whole.

Embodiments of the invention include a system that generates a single group photo with all faces therein expressing a desired emotion. A collection of group photos is obtained by the system to generate the user-desired group photo. The system can analyse the facial expression of each person in the collection of group photos. The user can provide his/her criteria to the system, including a facial expression. Thereafter the processor of the system can analyse the collection of group photos to detect the optimize portions (i.e. faces) that are closest to the desired appearance. The processor can blend these portions (i.e. facial images) into a composite image.

The criteria may also include context. The system can generate multiple images with different contexts/facial expressions (according to different criteria entered by the user) from a collection of group photos. The number of composite images produced will correspond to the number of combinations between the desired context and the desired facial expression.

Multiple photos (i.e. a burst) can be obtained when a user presses the shutter button of a camera or other device. It is also possible to use a “pre-photo” setting to take photos in anticipation of the user pressing the shutter button. This function maximizes the number of available captured group photos. As the shutter button of the camera has not been pressed, the photos taken during this period can provide more facial expressions for the subsequent use. Similarly, photos can be taken after release of the shutter button in “multiple-image capturing mode.”

Further, if a facial expression does not exist in the group of images, the system can synthesize (i.e. morph) an expression onto a face according to user input.

### INTRODUCTION

In a first embodiment, there is provided a method for producing an optimal or user-desired group photo from a collection of group photos comprising of the steps of:
a) obtaining a collection of group photos, each containing one or more faces;
b) conducting group analysis on the collection of group photos;
c) receiving input from a user comprising a desired facial expression;
d) selecting a photo from the collection of group photos as a base image;
e) selecting an area of a photo from the collection of group photos for a first detected face, wherein the selected area contains at least a portion of the first detected face with the desired facial expression;
f) repeating the step of e) for each additional detected face so that there is one selected area for each detected face;
g) transferring all the selected areas into the base image;
h) compensating variations between the base image and each selected area to produce a composite image; and
i) providing the composite image as the user-desired group photo.

In a second embodiment, there is provided a system for producing an optimal or user-desired group photo from a collection of group photos, comprising:

a processor;

a user interface; and

a memory medium containing program instructions;

wherein the program instructions are executable by the processor to:
a) obtain a collection of group photos, each containing one or more faces;
b) conduct group analysis on the collection of group photos;
c) receive input from a user comprising a desired facial expression;
d) select a photo from the collection of group photos as a base image;
e) select an area of a photo from the collection of group photos for a first detected face, wherein the selected area contains at least a portion of the first detected face with the desired facial expression;
f) repeat the step of e) for each additional detected face so that there is one selected area for each detected face;
g) transfer the selected areas onto the base image;
h) compensate variations between the base image and each selected area to produce a composite image; and
i) provide the composite image as the user-desired group photo.

### BRIEF DESCRIPTION OF THE FIGURES

The summary above, as well as the following detailed description of illustrative embodiments, is better understood when read in conjunction with the appended drawings. For the purpose of illustrating the disclosure, exemplary constructions of the disclosure are shown in the drawings. However, the disclosure is not limited to specific methods and instrumentalities disclosed herein. Wherever possible, like elements have been indicated by identical numbers.

FIG. 1 depicts the process of generating an optimal or user-desired photo from faces taken from a collection of group photos, according to an embodiment.

FIG. 2 is a flow chart of a process for analyzing a collection of group photos and generating an optimal or user-desired group photo, according to an embodiment.

FIG. 3 is a flow chart that depicts the pre-photo taking system, according to an embodiment of the invention.

FIG. 4 depicts user interfaces that can be used with the system, PART A of FIG. 4 depicts a two-dimensional disk interface for a user to input a desire emotion, according to an embodiment of the invention.

PART B of FIG. 4 depicts a linear interface for a user to input a desire emotion, according to an embodiment of the invention.

PART C of FIG. 4 depicts a categorical interface or a user to input a desire emotion, according to an embodiment of the invention,

FIG. 5 depicts an interface for a user to input a desire emotion along with a desired context, according to an embodiment of the invention.

FIG. 6 is a flow chart that depicts an example of the steps in obtaining and analyzing a collection of group photos to generate an optimal, user-desired image, according to an embodiment of the invention.

### DETAILED DESCRIPTION

### Definitions

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The term “app” or “application” refers to a self-contained program or piece of software designed to fulfil a particular purpose, especially as downloaded onto a mobile device.

The term “context” refers to the set of circumstances or facts that surround a particular event, situation, etc. Context can be, for example, professional, family, couple, vacation, party or funny.

The term “facial expression” refers to one or more motions or positions of the muscles beneath the skin of the face. People can interpret emotion based on the facial expression of a person's face.

The term “morphing” refers to the transformation of an image, and more specifically, to a special effect that changes one image into another through a seamless transition.

The term “pre-photo” refers to an image capturing device (e.g. a digital camera or smart phone) that can take photos before the user presses the shutter button. For example, the device can anticipate that a user is likely to take a photo based on lighting, the presence of multiple individuals in a field of view, position and movement of the device. The device can begin to record photos even though the user has not activated the device by pressing the shutter button.

The term “photo” or “photograph” refers to an image created by light falling on a light-sensitive surface. As used herein, a photo is recorded digitally and stored in a graphic format such as a JPEG, TIFF or RAW file.

The term “Viola-Jones object detection framework” refers to an object detection framework to provide competitive object detection rates in real-time. Although it can be trained to detect a variety of object classes, it was motivated primarily by the problem of face detection.

Other technical terms used herein have their ordinary meaning in the art that they are used, as exemplified by a variety of technical dictionaries.

### Description of Preferred Embodiments

The particular values and configurations discussed in these non-limiting examples can be varied and are cited merely to illustrate at least one embodiment and are not intended to limit the scope thereof.

When taking group photos, the larger the group, the more difficult it can be to take a good photo. Inevitably, not everyone in the group will have the desired facial expression. Normally, a photographer will announce a countdown before pressing the shutter button. Theoretically, this helps reduce inconsistency among the group members at the time of pressing the shutter button. Yet even with diligent efforts, a group member may be looking away, closing their eyes, not maintaining the desired facial expression, etc.

After realizing that a group photo is inadequate, a photographer may be unable to take another photo. The setting may have changed, a member may have left or the mood of the group members may have changed. To generate a desired photo with the minimum effort and time, the present invention obtains a collection of group photos and provides an optimal or user-desired photo based on individual portions from the collection. It is desirable to provide an improved system and method for producing optimal group photos. The optimal photos should be produced with minimal time and effort. The system and method should allow a user to provide his/her desired criteria for an optimal photo in a simple manner. The system should automatically review individual faces among groups of photos to provide one or more optimal group photos.

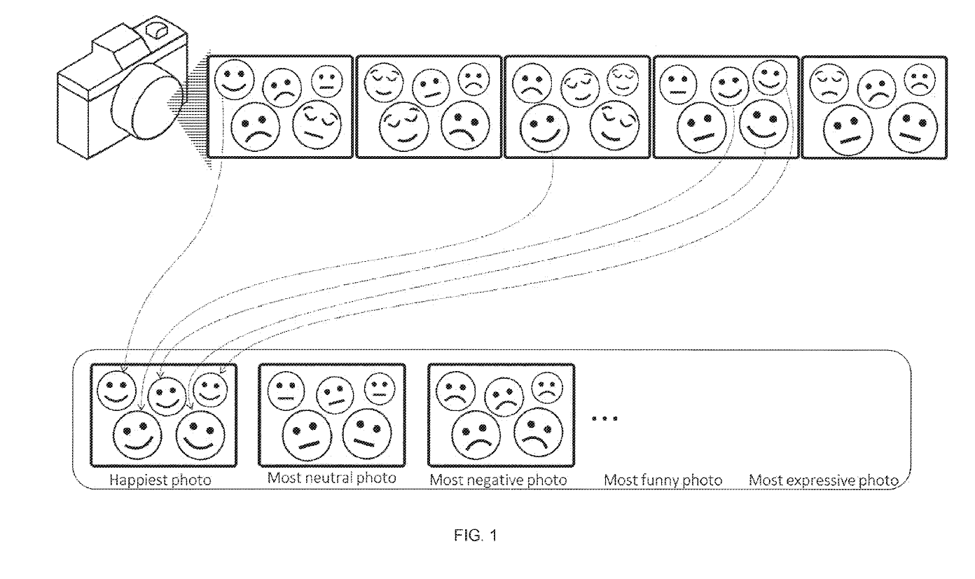

FIG. 1 depicts how an optimal or user-desired group photo can be generated from a collection of group photos, according to an embodiment of the invention. A user can input information about their desired context and desired facial expression. One or more faces are detected in each photo of the collection. The system detects each face among the collection of photos and then analyses each face. There can be multiple expressions for each person in the collection of photos. The person may also be blinking and/or non-ideally positioned (e.g. directed away from the camera). The system analyses the facial expression of that person's face (along with their position and eyes) to characterize the expression and its suitability based on their eyes and position. Thereafter the system can select a desired face for each person based on criteria that includes user input. The user can choose from one of many desired facial expressions.

The user can provide input for context and facial expression before or after taking the collection of group photos. The user can also modify the input to obtain multiple photos with different contexts and/or facial expressions. This allows the user to obtain, for example, both an optimal “happy” photo and an optimal “neutral” photo from the collection of group photos.

The process can begin with the selection of a base image. A base image can be selected based on the user's input of the desired context. For example, context can help define what is most appropriate for a photo. For a professional photo, people displaying neutral body language with low intensity facial expressions may be preferred. In contrast, for a party/festive photo, more active poses and intense facial expressions may be preferred.

The system can automatically analyze the collection of group photos to select a photo that most closely resembles the desired context chosen by the user. Features that are analyzed for determining the context and selection of base image can include body pose, proxemics, group gist and image quality. Thereafter, individual faces can be superimposed onto the base image.

The system can then identify individual faces among the collection of group photos. The individual faces can be grouped for a specific person and analyzed for quality and emotion. The system can choose the most appropriate face for each individual based on the emotion entered by the user. Common facial expressions include anxiety, disgust, embarrassment, fear, happiness, joy and worry.

In the next step, each of the selected faces is transferred to the base image. The transferred image therefore includes a face of each person with the desired facial expression in a desired context.

The number of images to be generated depends on the number of combinations of desired context and desired facial expression. The system can generate multiple images based on choices of a user. That is, multiple images can be generated based on different contexts and facial expressions. For example, if a user inputs a single context and a single facial expression, a single image can be generated based on that criteria. If a user inputs two contexts and a single facial expression, two images can be generated. Similarly, if the user inputs two contexts and two facial expressions, four images can be generated.

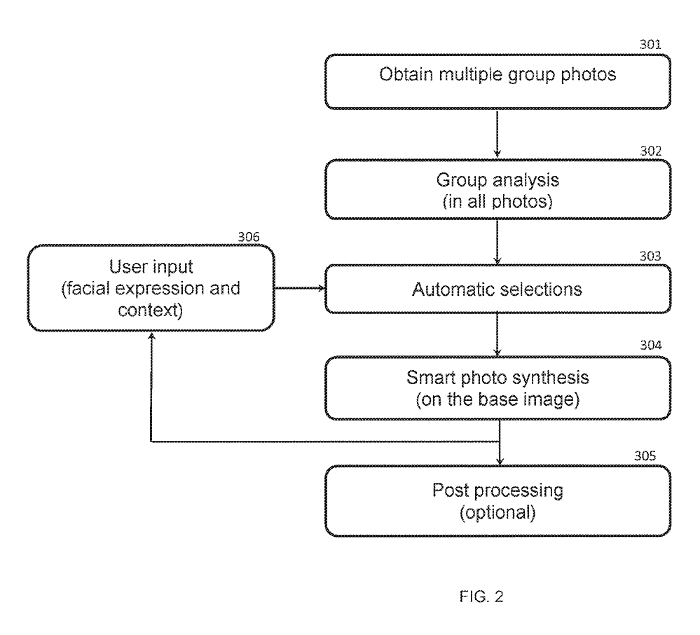

FIG. 2 is a flow chart that depicts an overview of a process for analyzing multiple images and generating an optimal or user-desired image according to criteria entered by the user. In the first step 301, a collection of group photos is obtained. The collection can be obtained using a “burst” function on a digital camera or smart phone. However, the collection can also be obtained from other sources, such as a computer, video recorder and/or a storage medium.

### Group Analysis

According to an embodiment, the system conducts a group analysis 302 on a collection of group photos. The group analysis can provide information to be used as a basis of selecting a base image and to select areas containing faces with desired facial expressions. The detection of the detailed facial information, such as Arousal-Valence-Intensity can help in identifying subtle expression differences.

To detect one or more faces in an image or collection of images, and to analyze facial expression, an algorithm that is capable of conducting the detection and/or analysis can be used. For example, the Viola-Jones object detection framework, deep learning, neural network, feature-based recognition, appearance-based recognition, template-based recognition, illumination estimation model, snake algorithm, Gradient Vector Flow can be used. Regardless of the approach, the face and body of each individual can be detected and distinguished from the background and other objects/individuals in a group photo.

In the step of group analysis 302, the system can detect individual faces. It can then analyze the image of each face among the collection to detect and characterize factors such as:
Body Pose
Head Pose
Gaze Direction
Eye Blinking
Emotions
Proxemics
Scene Understanding
image Quality
Saliency Detection
   Based on the group analysis, the system can select individual faces 303 to be compiled in a user-desired image.

In addition to detecting each member of the group, the system can also detect persons who do not belong to the group. Those persons that do not belong to the group will be categorized as irrelevant and excluded from further processing. For example, one or more pedestrians captured in a group photo or one or more persons that appear to be away from the group (e.g. in the background) will be deemed irrelevant and no further processing on these persons will be conducted.

A person can express many kinds of emotion, such as: affection, anger, angst, anguish, annoyance, anticipation, anxiety, apathy, arousal, awe, boredom, confidence, contempt, contentment, courage, curiosity, depression, desire, despair, disappointment, disgust, distrust, ecstasy, embarrassment, empathy, enthusiasm, envy, euphoria, fear, frustration, gratitude, grief, guilt, happiness, hatred, hope, horror, hostility, humiliation, interest, jealousy, joy, loneliness, love, lust, outrage, panic passion, pity, pleasure, pride, rage, regret, remorse, resentment, sadness, saudade, schadenfreude, self-confidence, shame, shock, shyness, sorrow, suffering, surprise, trust, wonder, etc. The system can detect the body position/posture, facial muscles (e.g. micro-expressions), eyelid/eye position, mouth/lip position etc. to characterize the facial expression of each face.

A user can provide information about a desired context and a desired facial expression 306. Based on the input of the user, the multiple group photos can be analyzed 303. Each individual in each group photo can be analyzed to estimate emotion based on feature points on an individual's face. Via facial emotion detection, expressions and/or micro-expressions can be used to analyze the relationship between points on the face. See, for example, US 2017/0105662 which describes an approach to estimating an emotion based on facial expression and analysis of one or more images and/or physiological data.

The photo that is the closest to the desired context will be chosen as the base image. For each person detected in the collection of group photos, an analysis can be conducted to select an area containing at least a portion of face with an expression that is the closest to the desired facial expression. After the base image and areas are selected, the areas are synthesized into the base image 304. The step can include compensation (i.e. adjusting the tone, contrast, exposure, size, etc.) of the selected areas to produce the desired image.

To generate a user-desired photo, it may be necessary to transfer different portions of other images into one image. Based on the desired context, a base image is selected. Further based on the desired facial expression, an area of an image from the multiple photos containing at least a portion of a person's face is detected. There is a selected area for each person in the multiple photos.

After each person in the collection of photos has one selected area, the system will transfer all the selected areas into the base image 304. With a proper compensation, between the selected areas and the base image, the base image and the selected areas are blended together in a seamless manner.

A post processing step 305 can be conducted to further enhance the generated photo. Each portion of an image can be enhanced in one of many manners, such as brightness improvement, skin improvement, color tonality adjustment, color intensity adjustment, contrast adjustment, filters, morphing and so on.

Although multiple images are used for processing, it is possible that a desired facial expression will not be found in the collection of group photos. In this situation, a new facial expression can be synthesized by morphing so that each of the people in the consolidated photo has a consistent facial expression.

In another embodiment, the system can function without user input. An optimal group photo can be produced based on default settings. For example, the system can choose faces and body positions that are facing toward the camera with eyes open. Lighting and image quality can also be considered. The system can compile an optimal group photo using default settings for context and expression such as “friendly” and “happy.”

In another embodiment, the system can extract context and/or facial expression autonomously. For example, the context can be extracted from clothes or dresses of individuals in the group while the facial expression can be extracted from the majority of facial expression. The system can identify context and expression as “friendly” and “happy” when most of the individuals are wearing bright colors and grinning or smiling. Likewise, context and expression can be identified as “professional” and “neutral” when a most of the individuals are wearing business attire and are exhibiting more blank expressions.

### System

According to an embodiment, a system for generating user-desired images can comprise at least one processor, a user interface and memory medium. The processor can conduct the steps for generating one or more desired images. A user interface can allow a user to input information about the desired image and mode of camera operation (e.g. automatic pre-photo taking). A memory medium can be used to store the necessary images.

### Acquisition of Multiple Images

According to an embodiment, multiple group photos are obtained from an image capturing device, such as a smart phone, computer, digital camera or a video recorder. The device can operate in a “multiple-image capturing mode,” in which multiple images are captured upon a single press on the shutter button. In the alternative, the device can operate in a video capturing mode to obtain a series of images from a video clip. As a video is comprised of multiple frames, multiple group photos can be obtained from a video. It is also possible to obtain a collection of group photos from a storage medium which stores multiple images and/or a video.

A “pre-photo” setting allows an image capturing device (e.g. a digital camera or smart phone) to take photos before the user presses the shutter button. The image capturing device can determine that a user will likely be capturing group photos before the shutter button is pressed. Based on this determination, it can begin recording images before the shutter button is pressed.

### Multiple-Image Capturing Mode

According to another embodiment, the collection of group photos can be captured by an image capturing device before and after the shutter button is pressed via “multiple-image capturing mode.” Multiple conditions can be configured in the system to trigger the capture of the collection of group photos before pressing the shutter button. For example, the device can detect multiple faces, minimal movement (image change) outside of a facial region and camera position through a gyroscope. These conditions can activate the device to record images even though a user has not yet pressed the shutter button (“pre-photo mode”). Thereafter, the camera can continue to record images for a brief period of time after the shutter button is released (“post-photo mode”) using the same criteria.

Before the shutter button is pressed, and when a group of people are posing, there can be a variety of expressions which can be used for subsequent processing. This can increase the size of the facial expression library and improve/optimize the final group photo.

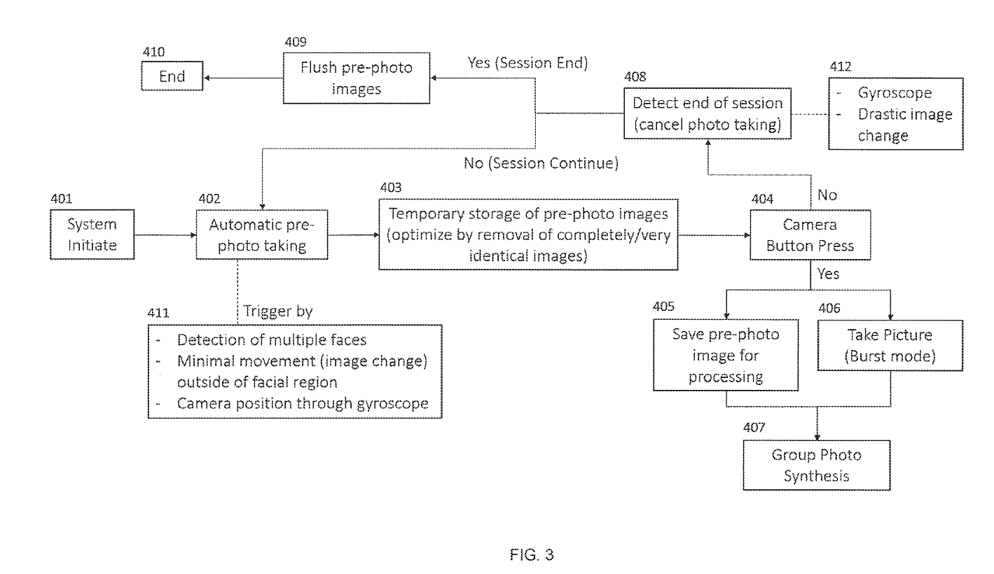

FIG. 3 is a flow chart that depicts the workflow of a system according to an embodiment. The system comprises at least a processor and at least a camera. Before starting the process, the system is initiated 401. After the system is initiated, the system can detect whether pre-photo mode should be activated 402.

Multiple features can be used to trigger the pre-photo taking mode 411, such as detection of multiple faces, minimal movement (image change) outside of facial region and camera position through gyroscope. If the pre-photo taking mode is triggered, multiple pre-photo images are taken and saved in temporary storage 403. Depending on the requirements, the pre-photo images can be optimized by removal of completely/very identical images. After multiple pre-photo images are taken and saved, the system detects whether the camera shutter button is pressed 404.

If the camera shutter button is pressed, the pre-photo images are saved for further processing 405. In the meantime, the camera can operate in a multiple-photo capturing mode (e.g. burst mode) 406 to capture multiple images. Thereafter, the images can be saved for further process.

If the camera shutter button is not pressed, the system will determine whether the session is finished or the photo taking task is cancelled 408. There are multiple features that can be used as the criteria for the determination of the end of the session, such as: gyroscope and drastic image change 412.

If the end of session is detected, the pre-photo images can be flushed 409. The pre-photo images can also be flushed if the shutter button was never pressed (i.e. the user did not manually take any photos). The end of the process 410 can follow. If the end of session is not detected, the system can enter the pre-photo taking mode.

According to an embodiment, an image capturing device for producing a user-desired image can comprise a processor, a user interface and a memory medium. The image capturing device can capture collections of group photos and generate one or more user-desired images based on the collection. A user inputs the information in regard to what is optimal and/or desired (i.e. context and emotion).

### User Interface

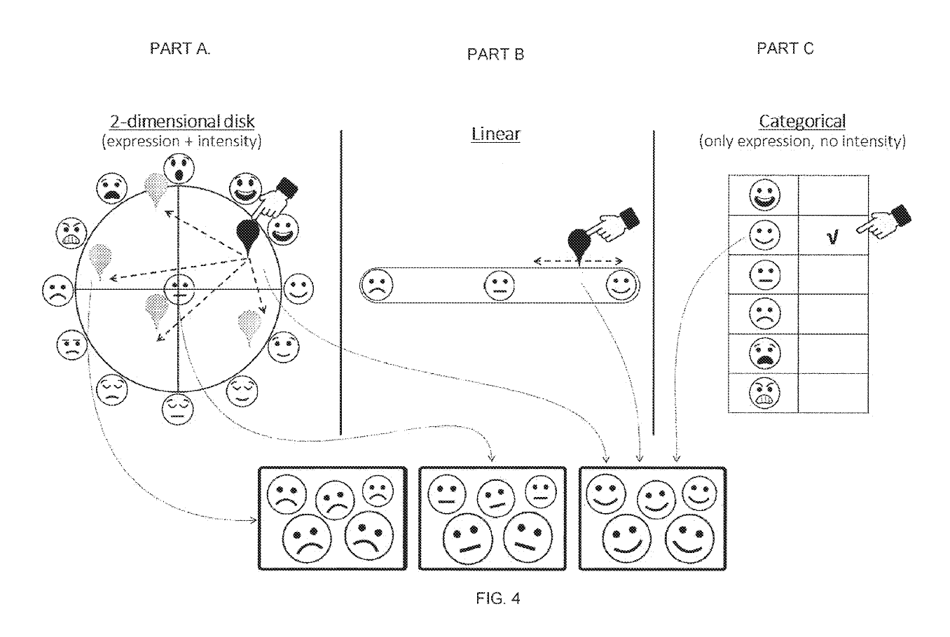

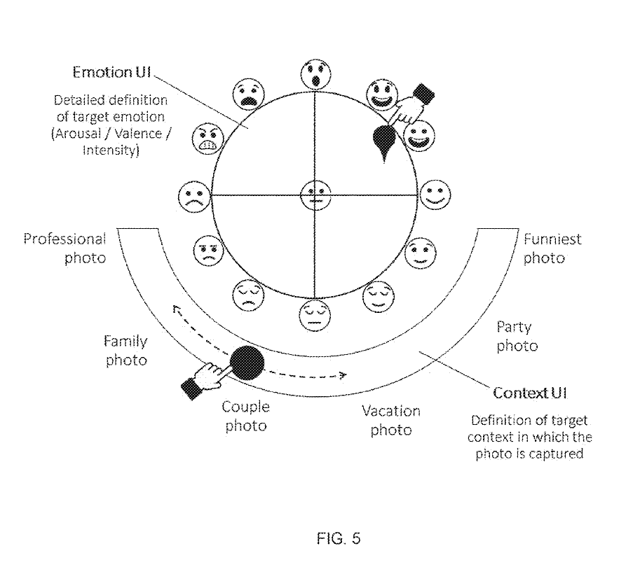

A user interface can be provided for the user to input a desired facial expression and/or desired context. FIGS. 4 and 5 depict user interfaces that can be used with the system. Each can use a touch screen on an imaging device such as a digital camera, video recorder, smart phone or computer having a processor that may be, in some embodiments, connected to a processing server via a network connection.

According to a first embodiment, the user interface provides a two-dimensional disk as depicted in PART A of FIG. 4. The disk comprises an abscissa and ordinate therein. The abscissa and ordinate can be used to represent two different pairs of facial expressions. For example, the abscissa can be used to represent sadness and happiness on each vertex (i.e. one vertex represents the saddest expression and the other represents the happiest expression) while the ordinate can be used to represent intense emotion and calm emotion at the vertexes. Those facial expressions that fall on the abscissa, on the ordinate or within the four quadrants formed by the abscissa and the ordinate, can be analyzed based on the distance from each of the four vertexes. If a facial expression is found to be nearer to the sad vertex and excited vertex (depending on the distance) the expression can be considered as angry, tension or other similar emotions. If a facial expression is found to be nearer to the intense emotion vertex and calm emotion vertex (depending on the distance) the expression can be considered as reserved, shy or other similar emotions. To select a desired emotion, the user can click anywhere within the disk.

According to an alternative embodiment, the user interface uses a linear sliding bar for the user to select a desired emotion by sliding the icon as depicted in PART B of FIG. 4. The two vertexes of the linear sliding rail represent two extreme emotions which oppose each other. Therefore, an emotion that is desired by the user depends on the distance between the icon and the vertexes.

According to another embodiment, the user interface uses a table with predetermined facial expressions. The user can choose an expression from the “selective table” as depicted in PART C of FIG. 4. The user can check the box of a desired facial expression. Six expressions, ranging from happy to angry, are depicted in this example.

According to another embodiment, the user interface uses a two-dimensional disk as depicted in FIG. 5. This provides a scrolling rail around the two-dimensional disk for the user to input the desired context. Context describes the style of image, such as professional, family, couple, vacation, party and funny. As in PART A of FIG. 4, the abscissa and ordinate can be used to represent facial expressions.

Each of the embodiments mentioned above provides a user interface which makes it easy for the user to input a desired context and/or facial expression. However, the user interface is not limited to the above configurations. Any other methods or manners that could enable a user to input information of its desired context and facial expression can be used with the embodiment.

The desired context and/or the desired facial expression can be input by the user each time before taking a group photo or each time after taking a photo. The desired context and/or the desired facial expression can also be input by the user as a default setting so that it is not necessary to input each time when taking photos. The system can also keep the input from the user as the default setting for the next use. The desired context and desired facial expression can be configured/input separately. For example, it can configure the desired context as default setting and input facial expression each time; or the other way around.

### Working Example

### Generation of an Optimal “Happy” Family Photo Based on User Preferences

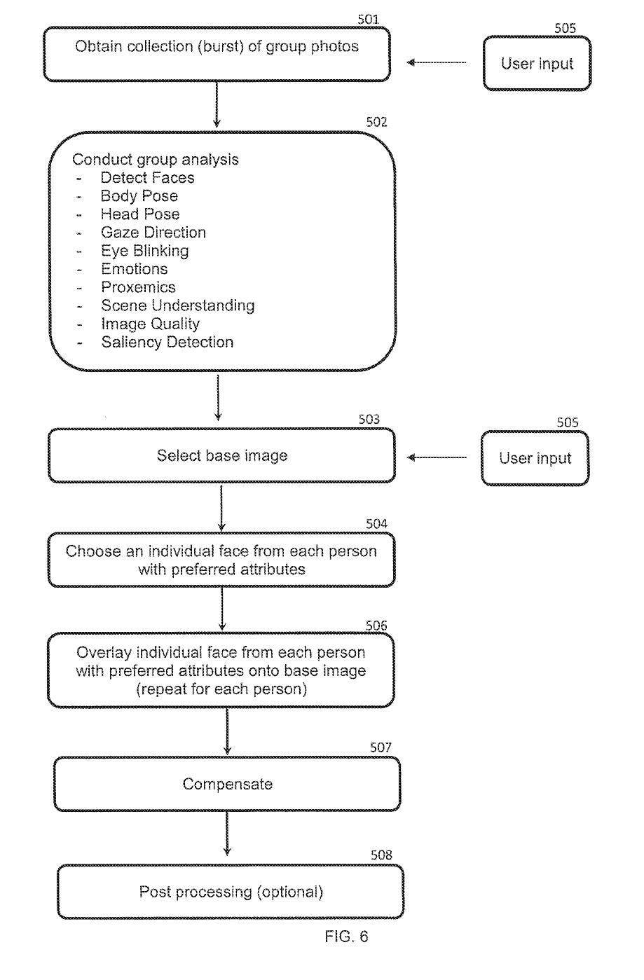

FIG. 6 is a flow chart that depicts the steps in obtaining and analyzing multiple group photos to generate a user-desired image according to some embodiments. As described above, a collection of group photos can be obtained 501 using an image capturing device such as a digital camera or smart phone.

The user can input his/her preferences (i.e. context and emotion) for use in the process 505. In a preferred method, the device will have default modes. In this example, the default context is “family photo” and the default emotion is “happy.” The user can also adjust settings of the imaging device. For example, he/she can choose to take multiple group photos manually, without the use of “pre-photo” and/or “burst” functions.

After a collection of group photos is obtained 501, the system can process the photos according to the following steps:
a) Conduct a group analysis on the collection of group photos 502. The system can analyse the detailed information in the photos, such as the number and position of faces, the body pose and head pose of different individuals, the direction of gaze and eye blinking for each face, the emotions that are expressed on each face and proxemics. The scene, image quality and saliency can also be detected. The group analysis can be used as the basis for further processing.
b) Select an image that is the most suitable for a “family photo” occasion as a base image 503, such as an image with positive body language and moderately high intensity facial expressions. In the alternative, the user can choose the base image 505.
c) Receive instructions from one or more users on the desired context and desired facial expression 505. For example, the user could input that the desired context is a “family photo” and the desired facial expression is “smile.” The user can input this information before or after obtaining the collection of group photos.
d) Identify individual faces 504 in the collection of group photos and group the individual faces from each person for further analysis. For a person detected in the collection of photos, select a smiling face among the faces of all photos which is the closest to the desired facial expression (i.e. smile in this example). Repeat this step until there is one face selected for each person. Therefore, there will be one selected face for each person that is the closest to the desired expression of smile.
e) Transfer or overlay the selected smiling face for each person to the base image (unless the ideal smiling face is already present on the base image). Thereafter save the smiling professional image to generate a composite image 506.
f) For the composite image, compensate for pose variations and blend them seamlessly 507.
g) Conduct image enhancement processes 508. For example, improving appearance of faces such as the brightness, skin appearance and color tonality. Further, if a facial expression is not found in the multiple images, synthesize a new expression with morphing.
h) If the user desires to generate other kinds of images, for example, a different context or a different facial expression, the user can input the new desired context and facial expression and the steps of (b) through (g) will be conducted again for the new desired image.

Those skilled in the relevant art will appreciate that embodiments can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

It will be appreciated that variations of the above disclosed and other features and functions, or alternatives thereof, may be combined into other systems or applications. Also, various unforeseen or unanticipated alternatives, modifications, variations or improvements therein may be subsequently made by those skilled in the art which are also intended to be encompassed by the following claims.

Although embodiments of the current disclosure have been described comprehensively, in considerable detail to cover the possible aspects, those skilled in the art would recognize that other versions of the disclosure are also possible.

What is claimed is:

1. A method for producing a user-desired group photo from a collection of group photos, the method comprising:
a) obtaining a collection of group photos, each group photo containing one or more faces;
b) conducting group analysis on the collection of group photos;
c) receiving input from a user comprising a desired facial expression;
d) selecting a group photo from the collection of group photos as a base image;
e) selecting an area of a group photo from the collection of group photos for a first detected face, wherein the selected area contains at least a portion of the first detected face with the desired facial expression;
f) repeating the step of e) for each additional detected face so that there is a selected area for each detected face;
g) transferring all of the selected area of each face onto the base image;
h) compensating variations between the base image and each selected area to produce a composite image; and
i) providing the composite image as the user-desired group photo,

2. The method of claim 1, wherein the collection of group photos is obtained from an image capturing device that operates in a multiple-image capturing mode and/or a video capturing mode.

3. The method of claim 1, wherein the collection of group photos is obtained both before and after a shutter button is pressed when operating in a multiple-image capturing mode.

4. The method of claim 1, wherein input from a user comprises a desired context.

5. The method of claim 4, wherein the base image is selected based on the desired context.

6. The method of claim 1, wherein the group analysis comprises analysis of face attributes, arousal, valance, body pose, head pose, gaze direction, eye blinking, emotions, proxemics, scene, image quality and/or saliency.

7. The method of claim 4, wherein the desired context comprises one or more of professional, family, couple, vacation, party and funny.

8. The method of claim 4, wherein the desired context and/or the desired facial expression are input via a user interface.

9. The method of claim 8, wherein the user interface is a two-dimensional disk, a linear sliding bar or a selective table.

10. The method of claim 1, wherein the desired facial expression comprises one or more of affection, anger, angst, anguish, annoyance, anticipation, anxiety, apathy, arousal, awe, boredom, confidence, contempt, contentment, courage, curiosity, depression, desire, despair, disappointment, disgust, distrust, ecstasy, embarrassment, empathy, enthusiasm, envy, euphoria, fear, frustration, gratitude, grief, guilt, happiness, hatred, hope, horror, hostility, humiliation, interest, jealousy, joy, loneliness, love, lust, outrage, panic passion, pity, pleasure, pride, rage, regret, remorse, resentment, sadness, saudade, schadenfreude, self-confidence, shame, shock, shyness, sorrow, suffering, surprise, trust, wonder and worry.

11. The method of claim 1, wherein at least one of body pose, proxemics, group mood and image quality, are considered in choosing the base image.

12. The method of claim 1, further comprising a step of enhancing the composite image.

13. A system for producing a user-desired group photo from a collection of group photos, comprising:
a processor;
a user interface; and
a memory medium containing program instructions;
wherein the program instructions are executed by the processor to implement a process of:
a) obtaining a collection of group photos, each containing one or more faces;
b) conducting group analysis on the collection of group photos;
c) receiving input from a user comprising a desired facial expression;
d) selecting a group photo from the collection of group photos as a base image:
e) selecting an area of a group photo from the collection of group photos for a first detected face, wherein the selected area contains at least a portion of the first detected face with the desired facial expression;
f) repeating the step of e) for each additional detected face so that here is one selected area for each detected face;
g) transferring the selected area of each face onto the base image;
h) compensating variations between the base image and each selected area to produce a composite image; and
i) providing the composite image as the user-desired group photo.

14. The system of claim 13, wherein the collection of group photos is obtained from an image capturing device that operates in a multiple-image capturing mode and/or a video capturing mode.

15. The system of claim 13, wherein the collection of group photos is obtained both before and after a shutter button is pressed when operating in a multiple-image capturing mode.

16. The system of claim 13, wherein input from a user comprises a desired context.

17. The system of claim 16, wherein the base image is selected based on the desired context.

18. The system of claim 13, wherein the group analysis comprises analysis of face attributes, arousal, valance, body pose, head pose, gaze direction, eye blinking, emotions, proxemics, scene, image quality and/or saliency.

19. The system of claim 16, wherein the desired context comprises one or more elements of the group of professional, family, couple, vacation, party and funny.

20. The system of claim 13, wherein the desired facial expression comprises one or more of affection, anger, angst, anguish, annoyance, anticipation, anxiety, apathy, arousal, awe, boredom, confidence, contempt, contentment, courage, curiosity, depression, desire, despair, disappointment, disgust, distrust, ecstasy, embarrassment, empathy, enthusiasm, envy, euphoria, fear, frustration, gratitude, grief, guilt, happiness, hatred, hope, horror, hostility, humiliation, interest, jealousy, joy, loneliness, love, lust, outrage, panic passion, pity, pleasure, pride, rage, regret, remorse, resentment, sadness, saudade, schadenfreude, self-confidence, shame, shock, shyness, sorrow, suffering, surprise, trust, wonder and worry.

21. The system of claim 13, wherein at least one of body pose, proxemics, group mood and image quality, are considered in choosing the base image.

22. The system of claim 13, wherein the program instructions further comprise program instructions to enhance the composite image.

23. The system of claim 13, wherein the program instructions further comprise program instructions to synthesize a new expression with morphing.

24. The system of claim 13, wherein the program instructions are repeated to produce a second user-desired group photo based on alternative input from the user.

25. The system of claim 16, wherein the desired context and/or the desired facial expression are input via a user interface.

26. The method of claim 25, wherein the user interface is a two-dimensional disk, a linear sliding bar or a selective table.
